(19) United States
(12) Patent Application Publication
(10) Pub. No.: US 2011/0318229 A1
(43) Pub. Date: Dec. 29, 2011

(54) DROPLET DISCHARGING APPARATUS FOR CELL COUNTING

(75) Inventors: Se Hoon Jeong, Seoul (KR); Sang Youl Jeon, Gyunggi-do (KR); Bo Sung Ku, Gyunggi-do (KR)

(73) Assignee: SAMSUNG ELECTRO-MECHANICS CO., LTD., Gyunggi-do (KR)

(21) Appl. No.: 12/902,036

(22) Filed: Oct. 11, 2010

(30) Foreign Application Priority Data
Jun. 28, 2010 (KR) 1020100061317

(51) Int. Cl. G01N 21/55

(52) U.S. Cl. 422/73

(57) ABSTRACT

There is provided a droplet discharging apparatus for cell counting that includes: a droplet flowing unit into which a droplet is injected; a pumping unit allowing the injected droplet to flow or to stop flowing; a droplet discharging unit discharging the droplet to a target unit or a receiving unit; a detection unit installed on a droplet discharging route, and irradiating light to the droplet and receiving light reflected on the droplet to generate a light receiving signal; and a control unit performing a control operation by counting the number of cells by receiving the light receiving signal from the detection unit and determining whether or not the cell is present on the basis of the level of the received light receiving signal. Therefore, it is possible to discharge the droplet by accurately counting the number of cells in the droplet.

### CROSS REFERENCE TO RELATED APPLICATION

This application claims the benefit of Korean Patent Application No. 10-2010-0061317, filed on Jun. 28, 2010, entitled “Droplet Discharging Apparatus For Cell Counting”, which is hereby incorporated by reference in its entirety into this application.

### BACKGROUND OF THE INVENTION

1. Technical Field

The present invention relates to a droplet discharging apparatus for cell counting.

2. Description of the Related Art

With the development of biotechnology, research of actual human cells in addition to plant and animal cells has been in active progress.

At this time, a very useful cell chip is used to detect composite physiological signs by cells which cannot be measured by the existing method through real-time reaction of living cells.

In general, the cell chip is called a microchip used to analyze various reaction aspects such as gene expression aspects, a gene defect, the generation of protein, and the like by fixing bacteria and cells such as animal cells onto the surface of a solid substrate made of silicon, surface modified glass, polypropylene, activated polyacrylamide, or the like.

The quantitative distribution of the cells is required in order to manufacture the cell chip. Very small amounts of cell suspension droplets are distributed to a narrow area on a substrate in order to manufacture a high-integration cell chip because the uniformity of the number of cells included in the small amounts of droplets is required.

Various methods and apparatuses for distributing a biomaterial suspension of DNA, protein, the animal cell, or the like in the form of the small amount of droplet are being proposed.

However, although the volume of the small amount of droplet is uniform, a certain amount of the biomaterial included in the small amount of droplet is necessarily not distributed.

In particular, when the cell suspension is distributed, the size of a particle of the cell suspension is large, as a result, the cell suspension is difficult to be uniformly distributed into the suspension, such that it is impossible to control the number of cells included in the droplet only by controlling the volume of the droplet.

Further, since the cells easily coagulate in the suspension and the viscosity of liquid is changed as time elapses, it is difficult to distribute the droplets in a certain volume and a deviation in the number of cells included in each droplet is increased.

A method of reducing the number of cells per unit volume, i.e., the concentration of the cell suspension, may be considered in order to uniformly distribute the cells in the suspension.

However, for example, when the concentration is decreased to approximately 105 cells/ml (=10-4 cell/pl), the droplet should be distributed at 10000 times in order to acquire a droplet including one cell by distributing each droplet of 1 pl (pico litter). Therefore, efficiency in manufacturing the cell chip is markedly deteriorated.

There is a demand for a droplet discharging apparatus capable of performing very accurate adjustment as many as the necessary number by adjusting the number of cells included in the droplet.

### SUMMARY OF THE INVENTION

The present invention has been made in an effort to provide a droplet discharging apparatus for cell counting that has a plurality of curves of a zigzag formed in a channel into which a droplet is injected and becomes narrow toward an outlet from an inlet to count the number of cells which is discharged through the outlet one by one.

A droplet discharging apparatus for cell counting according to an exemplary embodiment of the present invention includes: a droplet flowing unit in which an inlet is formed at one end and an outlet is formed at the other end, a droplet including a plurality of cells is injected through the inlet, a channel having a plurality of curves formed in a zigzag is formed between the inlet and the outlet so as to maintain the cells to be spaced from each other by a predetermined space when the injected droplet flows to the outlet, and opening/closing members which can be opened or closed are formed at each of the inlet and the outlet; one or more pumping units installed on the channel and allowing the droplet injected into the channel to flow to the outlet or to stop flowing; a droplet discharging unit formed by a discharge conduit in which a first discharge hole having the same size as a diameter of the outlet is formed at one end to be connected to the outlet and a second discharge hole is formed at the other end to discharge the droplet discharged through the outlet to a target unit or a receiving unit; a detection unit installed on a droplet discharging route of the droplet discharging unit, and irradiating light to the droplet on the droplet discharging route and receiving light reflected on the droplet so as to generate a light receiving signal; and a control unit turning on or turning off the pumping unit to allow the droplet in the channel to flow to the outlet or to stop flowing, counting the number of cells by receiving the light receiving signal from the detection unit and determining whether or not the cell is present on the basis of the level of the received light receiving signal, and controlling the opening/closing member of the outlet by comparing the predetermined number of cells with the counted number of cells.

The channel becomes narrow toward the outlet from the inlet and the diameter of the inlet is larger than that of the outlet.

The diameter of the outlet is 80 to 200% of the maximum cell diameter so as to discharge the cells included in the droplet through the outlet only one by one.

The opening/closing members of the inlet and the outlet are slide-type valves.

The pumping unit is a pulsating pump.

The channel of the droplet flowing unit and the discharge conduit of the droplet discharging unit are formed integrally with each other.

The outlet of the channel is joined with the first discharge hole of the discharge conduit by a joining member.

The detection unit includes: a light emitting device irradiating light to the droplet on the droplet discharging route; and a photo detector generating a light receiving signal by receiving light reflected on the droplet.

The droplet discharging apparatus further includes a droplet suction unit which is in the off state or standby state when the cell is present in the droplet on the droplet discharging route and which sucks the droplet on the droplet discharging route to return the droplet into the channel when the cell is not present.

The droplet suction unit includes: a suction conduit that has a first terminal connected to the discharge conduit between the detection unit and the second discharge hole and a second terminal connected to the channel between the detection unit and the inlet so as to allow the droplet to flow; and a droplet suction member that is inserted between the first terminal of the suction conduit and the discharge conduit at a location corresponding to the first terminal or inserted into the first terminal of the suction conduit to suck the droplet on the droplet discharge route.

The suction conduit 141 may be formed integrally with the channel and the discharge conduit.

One end of the droplet suction member is joined with the first terminal of the suction conduit by a joining member and the other end of the droplet suction member is joined with the discharge conduit at a location corresponding to the first terminal by the joining member.

The second terminal of the suction conduit is joined with the channel at a location corresponding to the second terminal by the joining member.

The droplet discharging apparatus further includes: an input unit receiving an input signal for setting the predetermined number of cells; and a storage unit storing the number of cells inputted from the input unit.

The storage unit stores the counted number of cells and the level of the light receiving signal depending on the types and sizes of the cells.

The control unit controls the opening/closing member of the inlet to be opened and the opening/closing member of the outlet to be closed at the time of injecting the droplet into the channel and controls the opening/closing member of the inlet to be closed when the injection of the droplet is completed.

The control unit controls the opening/closing member of the outlet to be opened when the droplet in the channel flows.

The control unit controls the detection unit to be turned on in order to detect the presence or not of the cell included in the droplet on the droplet discharging route when the opening/closing member of the outlet is opened to discharge the droplet in the channel to the droplet discharging unit through the outlet and the detection unit to be turned off when the opening/closing member of the outlet is closed not to discharge the droplet in the channel to the droplet discharging unit through the outlet.

The control unit determines whether or not the cell is present in the droplet on the basis of the level of the light receiving signal by receiving the light receiving signal generated from the detection unit and counts the number of cells whenever the cell is present.

The control unit controls the opening/closing member of the outlet to be opened before the counted number of cells reaches the predetermined number of cells and the opening/closing member to be closed when the counted number of cells reaches the predetermined number of cells.

### BRIEF DESCRIPTION OF THE DRAWINGS

FIG. 1 is a functional block diagram of a droplet discharging apparatus for cell counting according to an exemplary embodiment of the present invention;

FIG. 2 is a schematic diagram of a part marked with A in the droplet discharging apparatus shown in FIG. 1; and

FIGS. 3 and 4 are diagrams for describing an operation of a droplet suction unit in a partial diagram of the droplet discharging apparatus shown in FIG. 2.

### DESCRIPTION OF THE PREFERRED EMBODIMENTS

Various objects, advantages and features of the invention will become apparent from the following description of embodiments with reference to the accompanying drawings.

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe most appropriately the best method he or she knows for carrying out the invention.

The above and other objects, features and advantages of the present invention will be more clearly understood from the following detailed description taken in conjunction with the accompanying drawings. In the specification, in adding reference numerals to components throughout the drawings, it is to be noted that like reference numerals designate like components even though components are shown in different drawings. Further, in describing the present invention, a detailed description of related known functions or configurations will be omitted so as not to obscure the subject of the present invention.

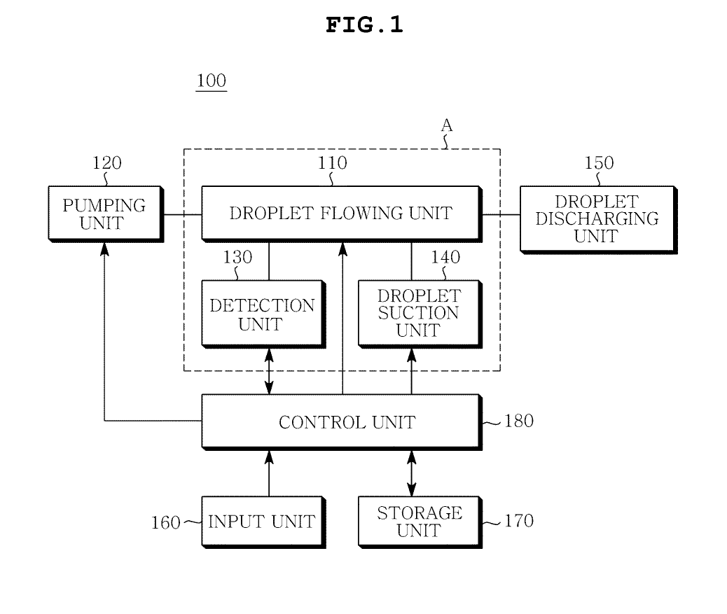

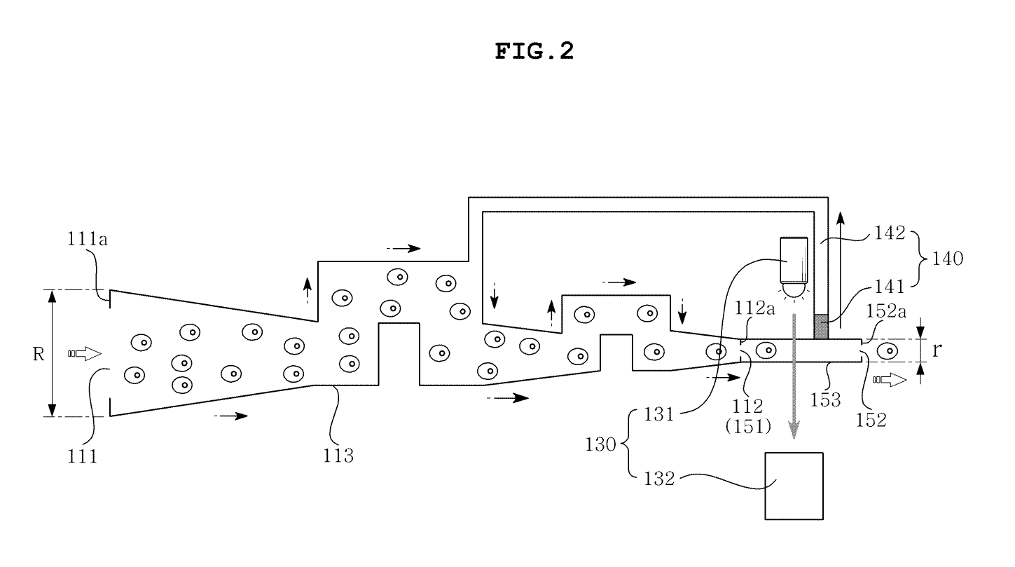

Hereinafter, preferred embodiments of the present invention will be described in detail with reference to the accompanying drawings. FIG. 1 is a functional block diagram of a droplet discharging apparatus for cell counting according to an exemplary embodiment of the present invention and FIG. 2 is a schematic diagram of a part marked with A in the droplet discharging apparatus shown in FIG. 1.

Referring to FIGS. 1 and 2, the droplet discharging apparatus 100 for cell counting according to the exemplary embodiment of the present invention includes a droplet flowing unit 110, a pumping unit 120, a detection unit 130, a droplet suction unit 140, a droplet discharging unit 150, an input unit 160, a storage unit 170, and a control unit 180.

In the droplet flowing unit 110, an inlet 111 is formed at one end and an outlet 112 is formed at the other end, a plurality of curves is formed between the inlet 111 and the outlet 112 in a zigzag, and a channel which becomes narrow toward the outlet 112 from the inlet 111 is formed, as a result, a diameter R of the inlet 111 is larger than a diameter r of the outlet.

At this time, the diameter r of the outlet 112 is preferably 80 to 200% of the maximum cell diameter so as to discharge each one of cells included in a droplet. Predetermined opening/closing members 111a and 112a such as a valve are mounted on the inlet 111 and the outlet 112 so as to open and close the inlet 111 and the outlet 112, respectively, when the droplet is injected or discharged and the injecting or discharging of the droplet is completed.

Herein, the opening/closing members 111a and 112a are not limited, but for example, a slide-type valve may be used as the opening/closing member.

The opening/closing members 111a and 112a may be manually opened and closed and may be automatically opened and closed in accordance with a control signal of the control unit 180.

Further, the droplet discharging unit 150 is connected to the outlet 112 of the channel 113 so as to easily discharge the cells discharged from the outlet 112 to a target unit where the discharged cells will be used or a receiving unit where the discharged droplet will be received.

The droplet discharging unit 150 is formed by a long tubular discharge conduit 153 in which a first discharge hole 151 having the same diameter as the outlet 112 and connected to the outlet 112 is formed at one end and a second discharge hole 152 is formed at the other end to discharge the droplet to the target unit or the receiving unit.

In addition, a predetermined opening/closing member 152a such as the valve is mounted on the second discharge hole 152 to be opened and closed at the time of discharging the droplet discharged through the outlet 112.

At this time, the opening/closing member 152a is not limited thereto, but for example, a slide type valve may be used and the opening/closing member 152a may be manually opened or closed and may be automatically opened or closed in accordance with the control signal of the control unit 180 in the same manner as the opening/closing members 111a and 112a of the inlet 111 and the outlet 112.

Further, the channel 113 and the discharge conduit 153 may be integrally formed or may be joined to each other by a predetermined joining member (not shown) formed at each of the outlet 112 of the channel 113 and the first discharge hole 151 of the discharge conduit 153.

Meanwhile, a droplet including a plurality of cells is injected into the channel 113 through the inlet 111.

The droplet flows to the outlet 112 in order to discharge the cells in the droplet injected into the channel 113, and when the discharging of the cells is completed, the droplet stops flowing.

The pumping unit 120 is not limited to a member for allowing the droplet in the channel 113 to flow to the outlet 112 or to stop flowing but for example, a pulsating pump may be used.

One or more pumping units 120 may be formed on the channel 113. Preferably, the pumping units 120 are installed adjacent to the inlet 111 such that all droplets injected into the channel 113 most efficiently and easily flow and stop flowing.

When the droplet in the channel 113 flows by operating the pumping unit 120, the cells in the droplet are spaced from each other by predetermined space while passing through the plurality of curves of the channel 113 formed in the zigzag.

Further, the cells are gradually arranged in line due to a structure of the channel which becomes narrow toward the outlet 112. When the cells are discharged through the outlet 112, the cells may be discharged only one by one because the diameter r of the outlet 112 is 80 to 200% of the maximum cell diameter.

Therefore, it is possible to control the cells of a desired number to be accurately discharged by counting the number of the cells that is discharged through the outlet 112 one by one.

As such, in order to count the number of the cells that are discharged through the outlet 112 one by one, the droplet discharging apparatus 100 according to the exemplary embodiment of the present invention is provided with the detection unit 130 for detecting whether or not the cell is present in the droplet discharged through the outlet 112.

The detection unit 130 is installed on the droplet discharging unit 150, more specifically, on a droplet discharging route through which the droplet is discharged from the outlet 112 to the second discharge hole 152. The detection unit 130 includes a light emitting device 131 irradiating light to the droplet on the droplet discharging route and a photo detector 132 generating a light receiving signal by receiving light reflected on the droplet.

When the opening/closing member 112a of the outlet 112 is opened by the control unit 180, the detection unit 130 allows the light emitting device 131 to irradiate light to the droplet in order to detect whether or not the cell is present in the droplet discharged through the outlet 112.

Thereafter, the photo detector 132 generates the light receiving signal by receiving the reflected light irradiated to the droplet and transfers the generated light receiving signal to the control unit 180.

At this time, the control unit 180 determines whether or not the cell is present in the droplet on the basis of the level of the light receiving signal (that is, a change of a received light amount) and when the cell is present, counts the number of the cells.

Herein, the light emitting device 131 is not limited, but for example, a light emitting diode (LED) may be used and the light receiving device 132 is not limited, but for example, a photo transistor, a photo FET, a photo IC, and the like may be used.

The droplet suction unit 140 is operated depending on the presence of the cell in the droplet detected by the detection unit 130. The droplet suction unit 140 includes a suction conduit 141 that has a first terminal connected to the discharge conduit 153 between the detection unit 130 and the second discharge hole 152 and a second terminal connected to the channel 113 between the detection unit 130 and the inlet 111 so as to allow the droplet to flow and a droplet suction member 142 that is inserted between the first terminal of the suction conduit 141 and the discharge conduit 153 at a location corresponding to the first terminal or inserted into the first terminal of the suction conduit 141 to suck the droplet.

At this time, the suction conduit 141 may be formed integrally with the channel 113 and the discharge conduit 153 or may be joined with the channel 113 and the discharge conduit 153 by a predetermined joining member (not shown) formed at each of the first and second terminals, and a predetermined joining member (not shown) formed at each of the discharge conduit 153 at a location corresponding to the first terminal and the channel 113 at a location corresponding to the second terminal.

Likewise, even when the droplet suction member 142 is inserted between the first terminal of the suction conduit 141 and the discharge conduit 153 at the location corresponding to the first terminal, the droplet suction member 142 is joined with the channel 113 and the discharge conduit 153 by predetermined joining members (not shown) formed at the first terminal of the suction conduit 141, both ends of the droplet suction member 142, and the discharge conduit 153 at the location corresponding to the first terminal.

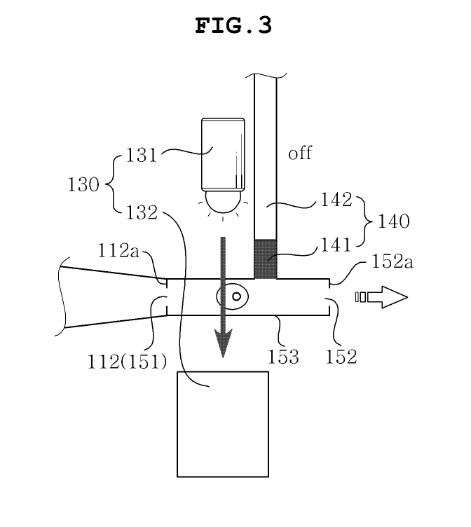

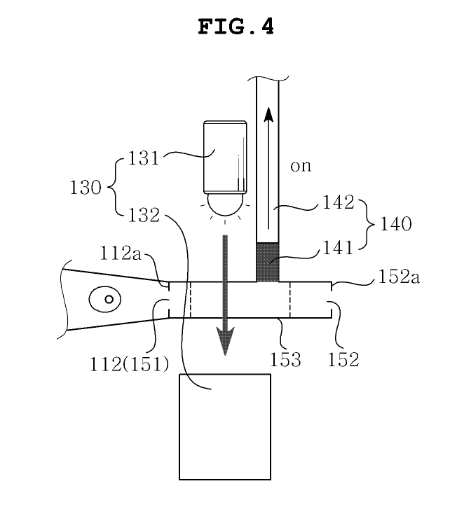

The operation of the droplet suction unit 140 will be described in detail with reference to FIGS. 3 and 4.

FIGS. 3 and 4 are diagrams for describing an operation of a droplet suction unit in the partial diagram of the droplet discharging apparatus shown in FIG. 2.

As shown in FIG. 3, when the droplet is discharged through the outlet 112, if the cell is detected by the detection unit 130 installed on the droplet discharging route, the droplet suction unit 140 maintain an off state or a standby state as it is.

However, as shown in FIG. 4, when the droplet is discharged to the outlet 112, if the cell is not detected by the detection unit 130 installed on the droplet discharging route, the droplet suction unit 140 is switched to an on state from the off state or standby state to start its operation.

That is, the droplet suction unit 140 sucks the droplet by using the droplet suction member 142 and returns the droplet to the channel 113 through the suction conduit 141 in order to prevent droplets not including the cells from being discharged to the second discharge hole 152.

By using the droplet suction unit 140, it is possible to prevent the droplet from being wasted by previously preventing only the droplet from being discharged at the time of discharging the cells and to constantly maintain the concentration of the droplet in the channel 113 by returning the corresponding droplet to the channel 113 again.

The opening/closing member 152a of the second discharge hole 152 is opened or closed by the control unit 180. The control unit 180 may control the opening/closing member 152a to be closed until the number of the discharged cells reaches the predetermined number of cells and be opened when the number of the discharged cells reaches the predetermined number of cells.

Referring back to FIG. 1, in regard to the predetermined number of cells, the number of cells to be discharged may be set at the time of designing the droplet discharging apparatus according to the exemplary embodiment of the present invention and may also be set through a predetermined input unit 160.

An input signal is inputted into the input unit 160 through a button, and the like by a user and the number of the cells to be discharged is set in accordance with the input signal inputted through the input unit 160.

The storage unit 170 stores the number of the cells to be discharged in accordance with the input signal inputted from the input unit 160 and stores the number of cells counted by the control unit 180.

Further, a look-up table where the level of the light receiving signal depending on the types or sizes of the cells, and the like is previously prepared is stored in the storage unit 170.

The control unit 180 controls the droplet flowing unit 110, the pumping unit 120, the detection unit 130, the droplet suction unit 140, the droplet discharging unit 150, the input unit 160, and the storage unit 170 on the whole.

Specifically, the control unit 180 controls the opening/closing members 111a and 112a of the inlet 111 and the outlet 112 to be opened or closed in order to inject or discharge the droplet into the channel 113 of the droplet flowing unit 110.

For example, the control unit 180 controls the opening/closing member 111a of the inlet 111 to be opened or the opening/closing member 112a of the outlet 112 to be closed in order to inject the droplet including the plurality of cells into the channel 113. Thereafter, when the injection is completed, the control unit 180 controls the opening/closing member 111a of the inlet 111 to be closed.

Further, the control unit 180 controls the pumping unit 120 to be turned on or turned off in order to allow the droplet including the plurality of cells in the channel 113 of the droplet flowing unit 110 to flow to the outlet 112 or to stop flowing.

For example, when the operation of the droplet discharging apparatus 100 for discharging predetermined cells is started, the control unit 180 controls the pumping unit 120 to be turned on and controls the opening/closing member 112a of the outlet 112 to be opened in order to allow the droplet in the injection-completed channel 113 to flow from the inlet 111 to the outlet 112.

Thereafter, the control unit 180 controls the detection unit 130 to be turned on in order to detect the presence or not of the cell included in the droplet on the droplet discharging route when the opening/closing member 112a of the outlet 112 is opened to discharge the droplet in the channel 113 to the droplet discharging unit 150 through the outlet 112, and controls the detection unit 130 to be turned off when the opening/closing member 112a of the outlet 112 is closed and thus, the droplet in the channel 113 is not discharged to the droplet discharging unit through the outlet 112.

When the detection unit 130 is turned on, the control unit 180 allows the light emitting device 131 of the detection unit 130 to irradiate light to the droplet on the droplet discharging route and allows the photo detector 132 of the detection unit 130 to receive light reflected on the droplet so as to generate a light receiving signal. The generated light receiving signal is transferred to the control unit 180.

Thereafter, the control unit 180 controls determining whether or not the cell is present in the droplet on the basis of the level of the received light receiving signal, counting the number of times when the cell is present whenever the cell is present and storing the counted number of times in the storage unit 170.

Further, the control unit 180 may determine the number of cells in the droplet by comparing the level of the light receiving signal depending on the number or sizes of cells stored in the previously prepared look-up table with the level of the light receiving signal transferred from the photo detector 132.

As such, the control unit 180 counts the number of cells by determining whether or not the cell is present in the droplet or counts the number of cells by comparing the number of cells with the previously prepared look-up table and thereafter, controls the opening/closing member 112a of the outlet 112 to be closed when the counted number of cells reaches the predetermined number of cells or the number of discharged cells set through input by the input unit 160.

At this time, the control unit 180 may control the second discharge hole 152 of the droplet discharging unit 150 to be closed before the counted number of cells reaches the predetermined number of discharged cells and to be opened at the time of discharging the droplet to the target unit or the receiving unit when the counted number of cells reaches the predetermined number of discharged cells.

In addition, when the detection unit 130 installed on the discharge route of the droplet discharging unit 150 detects whether or not the cell is present in the droplet, the control unit 180 may control the droplet suction unit 140 to be in the off state or standby state when the cell is present and the droplet suction unit 140 to be turned on to suck the droplet, thereby returning the droplet into the channel 113 when the cell is not present.

As described above, the droplet discharging apparatus 100 according to the exemplary embodiment of the present invention counts the number of cells in the droplet discharged through the outlet 112 by discharging the cells in the droplet through the outlet 112 one by one so as to control the accurate number of discharged cells.

According to an embodiment of the present invention, it is possible to accurately adjust the number of cells by counting the number of cells included in a droplet to easily control the number of cells, as a result, it is possible to save time and cost.

Although the embodiments of the present invention has been disclosed for illustrative purposes, those skilled in the art will appreciate that various modifications, additions and substitutions are possible, without departing from the scope and spirit of the invention. Accordingly, any and all modifications, variations or equivalent arrangements should be considered to be within the scope of the invention, and the detailed scope of the invention will be disclosed by the accompanying claims.

What is claimed is:

1. A droplet discharging apparatus for cell counting, comprising:
a droplet flowing unit in which an inlet is formed at one end and an outlet is formed at the other end, a droplet including a plurality of cells is injected through the inlet, a channel having a plurality of curves formed in a zigzag is formed between the inlet and the outlet so as to maintain the cells to be spaced from each other by a predetermined space when the injected droplet flows to the outlet, and opening/closing members which can be opened or closed are formed at each of the inlet and the outlet;
one or more pumping units installed on the channel and allowing the droplet injected into the channel to flow to the outlet or to stop flowing;
a droplet discharging unit formed by a discharge conduit in which a first discharge hole having the same size as a diameter of the outlet is formed at one end to be connected to the outlet and a second discharge hole is formed at the other end to discharge the droplet discharged through the outlet to a target unit or a receiving unit;
a detection unit installed on a droplet discharging route of the droplet discharging unit, and irradiating light to the droplet on the droplet discharging route and receiving light reflected on the droplet so as to generate a light receiving signal; and
a control unit turning on or turning off the pumping unit to allow the droplet in the channel to flow to the outlet or to stop flowing, counting the number of cells by receiving the light receiving signal from the detection unit and determining whether or not the cell is present on the basis of the level of the received light receiving signal, and controlling the opening/closing member of the outlet by comparing the predetermined number of cells with the counted number of cells.

2. The droplet discharging apparatus for cell counting as set forth in claim 1, wherein the channel becomes narrow toward the outlet from the inlet and the diameter of the inlet is larger than that of the outlet.

3. The droplet discharging apparatus for cell counting as set forth in claim 1, wherein the diameter of the outlet is 80 to 200% of the maximum cell diameter so as to discharge each one of cells included in the droplet through the outlet.

4. The droplet discharging apparatus for cell counting as set forth in claim 1, wherein the the opening/closing members of the inlet and the outlet are slide-type valves.

5. The droplet discharging apparatus for cell counting as set forth in claim 1, wherein the pumping unit is a pulsating pump.

6. The droplet discharging apparatus for cell counting as set forth in claim 1, wherein the channel of the droplet flowing unit and the discharge conduit of the droplet discharging unit are formed integrally with each other.

7. The droplet discharging apparatus for cell counting as set forth in claim 1, wherein the outlet of the channel is joined with the first discharge hole of the discharge conduit by a joining member.

8. The droplet discharging apparatus for cell counting as set forth in claim 1, wherein the detection unit includes:
a light emitting device irradiating light to the droplet on the droplet discharging route; and
a photo detector generating a light receiving signal by receiving light reflected on the droplet.

9. The droplet discharging apparatus for cell counting as set forth in claim 1, further comprising a droplet suction unit which is in the off state or standby state when the cell is present in the droplet on the droplet discharging route and which sucks the droplet on the droplet discharging route to return the droplet into the channel when the cell is not present.

10. The droplet discharging apparatus for cell counting as set forth in claim 9, wherein the droplet suction unit includes:
a suction conduit that has a first terminal connected to the discharge conduit between the detection unit and the second discharge hole and a second terminal connected to the channel between the detection unit and the inlet so as to allow the droplet to flow; and
a droplet suction member that is inserted between the first terminal of the suction conduit and the discharge conduit at a location corresponding to the first terminal or inserted into the first terminal of the suction conduit to suck the droplet on the droplet discharge route.

11. The droplet discharging apparatus for cell counting as set forth in claim 10, wherein the suction conduit is integrally formed with the channel and the discharge conduit.

12. The droplet discharging apparatus for cell counting as set forth in claim 10, wherein one end of the droplet suction member is joined with the first terminal of the suction conduit by a joining member and the other end of the droplet suction member is joined with the discharge conduit at a location corresponding to the first terminal by the joining member.

13. The droplet discharging apparatus for cell counting as set forth in claim 10, wherein the second terminal of the suction conduit is joined with the channel at a location corresponding to the second terminal by the joining member.

14. The droplet discharging apparatus for cell counting as set forth in claim 1, further comprising:
an input unit receiving an input signal for setting the predetermined number of cells; and
a storage unit storing the number of cells inputted from the input unit.

15. The droplet discharging apparatus for cell counting as set forth in claim 14, wherein the storage unit stores the counted number of cells and the level of the light receiving signal depending on the types and sizes of the cells.

16. The droplet discharging apparatus for cell counting as set forth in claim 1, wherein the control unit controls the opening/closing member of the inlet to be opened and the opening/closing member of the outlet to be closed at the time of injecting the droplet into the channel and controls the opening/closing member of the inlet to be closed when the injection of the droplet is completed.

17. The droplet discharging apparatus for cell counting as set forth in claim 1, wherein the control unit controls the opening/closing member of the outlet to be opened when the droplet in the channel flows.

18. The droplet discharging apparatus for cell counting as set forth in claim 1, wherein the control unit controls the detection unit to be turned on in order to detect the presence or not of the cell included in the droplet on the droplet discharging route when the opening/closing member of the outlet is opened to discharge the droplet in the channel to the droplet discharging unit through the outlet and the detection unit to be turned off when the opening/closing member of the outlet is closed not to discharge the droplet in the channel to the droplet discharging unit through the outlet.

19. The droplet discharging apparatus for cell counting as set forth in claim 1, wherein the control unit determines whether or not the cell is present in the droplet on the basis of the level of the light receiving signal by receiving the light receiving signal generated from the detection unit and counts the number of cells whenever the cell is present.

20. The droplet discharging apparatus for cell counting as set forth in claim 1, wherein the control unit controls the opening/closing member of the outlet to be opened until the counted number of cells reaches the predetermined number of cells and the opening/closing member to be closed when the counted number of cells reaches the predetermined number of cells.
